(19) United States
(12) Patent Application Publication
(10) Pub. No.: US 2025/0187069 A1
(43) Pub. Date: Jun. 12, 2025

(54) POST-PROCESSING DEVICE OF CAST PRODUCT

(71) Applicants: HYUNDAI MOTOR COMPANY, Seoul (KR); KIA CORPORATION, Seoul (KR)

(72) Inventors: Taewan Kim, Hwaseong-si (KR); Tae Jong Yoon, Hwaseong-si (KR)

(73) Assignees: HYUNDAI MOTOR COMPANY, Seoul (KR); KIA CORPORATION, Seoul (KR)

(21) Appl. No.: 18/917,467

(22) Filed: Oct. 16, 2024

(30) Foreign Application Priority Data
Dec. 8, 2023 (KR) 10-2023-0177519

(51) Int. Cl. B22D 31/00; B23P 15/00

(52) U.S. Cl. CPC B22D 31/002; B23P 15/00

(57) ABSTRACT

A post-processing device of a cast product is configured to post-process the cast product in which a plurality of components is integrated. In particular, the post-processing device may include i) a first press mold configured to trim cast scraps of the cast product and process at least one hole into the cast product, and ii) a second press mold configured to calibrate dimensions of the plurality of components and fasten hardware to the at least one hole.

### CROSS-REFERENCE TO RELATED APPLICATION

This application claims priority to and the benefit of Korean Patent Application No. 10-2023-0177519, filed in the Korean Intellectual Property Office on Dec. 8, 2023, the entire contents of which are incorporated herein by reference.

### BACKGROUND

### (a) Field

The present disclosure relates to a post-processing device of a cast product, and more particularly, to a post-processing device of a cast product capable of performing a post-processing process of a large cast product.

### (b) Description of the Related Art

In general, a casting method is a method of injecting molten metal into a casting mold to change a phase of the molten metal into a solid state, and molding a product with a set shape. For example, components constituting a vehicle body may be molded by using the casting method.

The vehicle body components molded using the casting method may be assembled together by welding and fastening, and may be configured as a standardized large vehicle body assembly.

In order to manufacture the standardized large vehicle body assembly, various post-processing processes of vehicle body components are required. An example of post-processing processes may include a process of managing the degree of dimensions of vehicle body components, cutting unnecessary parts of vehicle body components, and processing holes for fastening hardware into vehicle body components.

Therefore, as post-processing processes of vehicle body components as described above are required, cycle time may be excessively taken to manufacture a vehicle body assembly.

In addition, the number of processing equipment for post-processing of vehicle body components increases, which may increase investment cost and installation space of processing equipment.

The matters described in the Background section are provided only to enhance the understanding of the background of the disclosure, and may include matters that are not already known to those of ordinary skill in the art to which this technology pertains.

### SUMMARY

The present disclosure provides a post-processing device of a cast product capable of post-processing a large cast product with a simple equipment and process by using press mold technology.

A post-processing device of a cast product according to an embodiment of the present disclosure is configured to post-process the cast product in which a plurality of components is integrated. The post-processing device may include i) a first press mold configured to trim cast scraps of the cast product and process at least one hole into the cast product, and ii) a second press mold configured to calibrate dimensions of the plurality of components and fasten hardware to the at least one hole.

In the post-processing device of the cast product according to an embodiment of the present disclosure, the cast product may be loaded on the first press mold by a first robot hanger.

In the post-processing device of the cast product according to an embodiment of the present disclosure, the cast product post-processed in the first press mold may be loaded on the second press mold by a second robot hanger.

According to an embodiment of the present disclosure, a post-processing device of a cast product is configured to post-process the cast product in which a plurality of components is integrated. The post-processing device may include i) a first press mold including a trimming unit installed on a first lower die and a first upper die to trim cast scraps of the cast product and ii) a second press mold including a dimension calibration unit installed in a second lower die and a second upper die to calibrate dimensions of the plurality of components.

In the post-processing device of the cast product according to an embodiment of the present disclosure, the first press mold may further include a piercing unit installed in the first lower die and the first upper die to process at least one hole into the cast product.

In the post-processing device of the cast product according to an embodiment of the present disclosure, the second press mold may further include a hardware fastening unit installed in the second lower die and the second upper die to fasten hardware to the at least one hole.

In the post-processing device of the cast product according to an embodiment of the present disclosure, the trimming unit may include a plurality of lower trimming steels installed in the first lower die, and a plurality of upper trimming steels installed in the first upper die in correspondence to the plurality of lower trimming steels.

In the post-processing device of the cast product according to an embodiment of the present disclosure, the piercing unit may include a piercing tool installed in the first upper die, and a tool support member installed in the first lower die in correspondence to the piercing tool.

In the post-processing device of the cast product according to an embodiment of the present disclosure, the piercing tool may be installed on a mounting block mounted on the first upper die.

In the post-processing device of the cast product according to an embodiment of the present disclosure, the piercing tool may be provided in the mounting block to be detachable from a plurality of mounting holes formed in different sizes.

In the post-processing device of the cast product according to an embodiment of the present disclosure, the dimension calibration unit may include: a first cam slide installed on the second upper die and configured to be slidably movable in a horizontal direction and having a first cam inclined surface formed thereon; and a first calibration block coupled to the first cam slide and configured to press calibration parts of the plurality of components. The dimension calibration unit may further include a first cam drive installed on the second lower die and configured to slidably move the first cam slide in a diagonal direction and having a first guide surface in cam contact with the first cam inclined surface.

In the post-processing device of the cast product according to an embodiment of the present disclosure, the dimension calibration unit may include a second cam slide installed on the second lower die and configured to be slidably movable in the horizontal direction and having a second cam inclined surface formed thereon; and a second calibration block coupled to the second cam slide and configured to press the calibration parts of the plurality of components. The dimension calibration unit may further include a second cam drive installed on the second upper die and configured to slidably move the second cam slide in the horizontal direction and having a second guide surface in cam contact with the second cam inclined surface.

In the post-processing device of the cast product according to an embodiment of the present disclosure, the hardware fastening unit may include: a hardware punch unit installed in the second upper die and configured to be movable in an up and down direction; and an anvil unit configured to plastically deform a hole processing unit of the cast product by a punch pressure of the hardware punch unit and installed on the second lower die to fasten the hardware to the hole processing unit.

According to another embodiment of the present disclosure, a post-processing device for a cast product includes: a first press module and a second press module. In particular, the first press mold includes: a trimming unit installed on a first lower die and a first upper die and configured to trim cast scraps of the cast product, and a piercing unit installed in the first lower die and the first upper die and configured to process at least one hole into the cast product. The second press mold includes: a dimension calibration unit installed in a second lower die and a second upper die and configured to calibrate dimensions of a plurality of components of the cast product; and a hardware fastening unit installed in the second lower die and the second upper die to fasten hardware to the at least one hole.

The embodiments of the present disclosure may post-process the large cast product by using the press mold, thereby shortening the cycle time, and reducing equipment investment costs and equipment installation space.

In addition, the effects obtainable or predicted by the embodiments of the present disclosure are to be disclosed directly or implicitly in the detailed description of the embodiments of the present disclosure. In other words, various effects predicted according to an embodiment of the present disclosure should be understood through the detailed description below.

### BRIEF DESCRIPTION OF THE DRAWINGS

Because these drawings are for reference in explaining the embodiments of the present disclosure, the technical idea of the present disclosure should not be construed as being limited to the accompanying drawings.

FIG. 1 is a block diagram schematically showing a post-processing device of a cast product according to an embodiment of the present disclosure.

FIG. 2 is a diagram illustrating a cast product applied to the post-processing device of the cast product according to an embodiment of the present disclosure.

FIG. 3 is a diagram showing a trimming unit applied to the post-processing device of the cast product according to an embodiment of the present disclosure.

FIG. 4 is a diagram showing a piercing unit applied to the post-processing device of the cast product according to an embodiment of the present disclosure.

FIG. 5 is a diagram showing a piercing tool of the piercing unit applied to the post-processing device of the cast product according to an embodiment of the present disclosure.

FIG. 6 is a diagram showing a hole part formed by the piercing unit applied to the post-processing device of the cast product according to an embodiment of the present disclosure.

FIGS. 7 and 8 are diagrams showing a dimension calibration unit applied to the post-processing device of the cast product according to an embodiment of the present disclosure.

FIG. 9 is a diagram showing a hardware fastening unit applied to the post-processing device of the cast product according to an embodiment of the present disclosure.

It should be understood that the drawings referenced above are not necessarily drawn to scale, but present a rather simplified representation of various features illustrating the basic principle of the present disclosure. For example, specific design features of the present disclosure including, for example, specific sizes, directions, positions, and shapes, are determined in part according to specifically intended applications and environments of use.

### DETAILED DESCRIPTION

The present disclosure is described more fully hereinafter with reference to the accompanying drawings, in which some embodiments of the disclosure are shown. As those having ordinary skill in the art would realize, the described embodiments may be modified in various different ways, all without departing from the spirit or scope of the present disclosure. However, the present disclosure may be implemented in many different forms and is not limited to the embodiments described herein.

The terms used herein are for describing specific embodiments and are not intended to limit the present disclosure.

In addition, as used herein, the singular form is also intended to include the plural forms unless the context clearly indicates otherwise.

It should also be understood that the terms “comprises” and/or “comprising,” when used herein, specify the presence of mentioned features, integers, steps, actions, elements and/or components, but do not exclude the presence or addition of one or more of other features, integers, steps, actions, components, and/or groups thereof.

As used herein, the term ‘coupled’ indicates the physical relationship between two components directly connected to each other or indirectly connected to each other through one or more intermediate components. When a component, device, element, or the like of the present disclosure is described as having a purpose or performing an operation, function, or the like, the component, device, or element should be considered herein as being “configured to” meet that purpose or to perform that operation or function.

The terms “vehicle,” “of a vehicle,” “automobile”, or other similar terms used herein generally may include passenger automobiles including passenger vehicles, sports utility vehicles (SUVs), buses, trucks, and various commercial vehicles, and may include hybrid vehicles, electric vehicles, hybrid electric vehicles, hydrogen power vehicles, electric vehicle-based purpose built vehicles (PBVs), and other alternative fuel vehicles (e.g. fuels derived from resources other than petroleum).

Hereinafter, with reference to the accompanying drawings, embodiments of the present disclosure are described in detail.

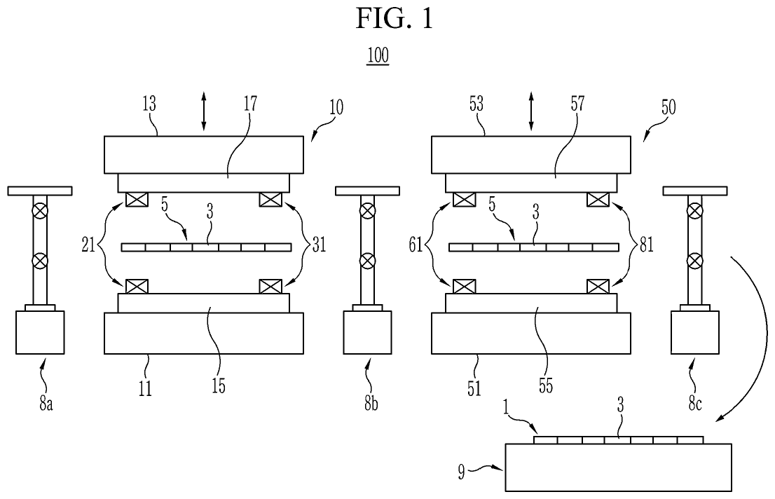

FIG. 1 is a block diagram schematically showing a post-processing device of a cast product according to an embodiment of the present disclosure.

Referring to FIG. 1, a post-processing device 100 of a cast product according to an embodiment of the present disclosure may be applied to a process of manufacturing a vehicle body assembly 1 in which a plurality of vehicle body components 3 are combined.

In one embodiment, the vehicle body assembly 1 may include an underbody assembly of a vehicle body. The vehicle body assembly 1 may be manufactured by using a casting method (for example, a high-pressure casting method or a low-pressure casting method) in which a cast product of the desired shape is molded by injecting molten aluminum alloy into a die.

Furthermore, the vehicle body assembly 1 may be manufactured through a process of molding a large cast product 5 in which the vehicle body components 3 are integrated by using the casting method and post-processing the cast product 5.

Those having ordinary skill in the art refer to, as a hyper casting method, a method of molding the large cast product 5 in which the vehicle body components 3 are integrated at once, rather than individually assembling vehicle body components molded by using the casting method as in the related art. In addition, those having ordinary skill in the art also refer to this method as a mega casting method or a giga casting method.

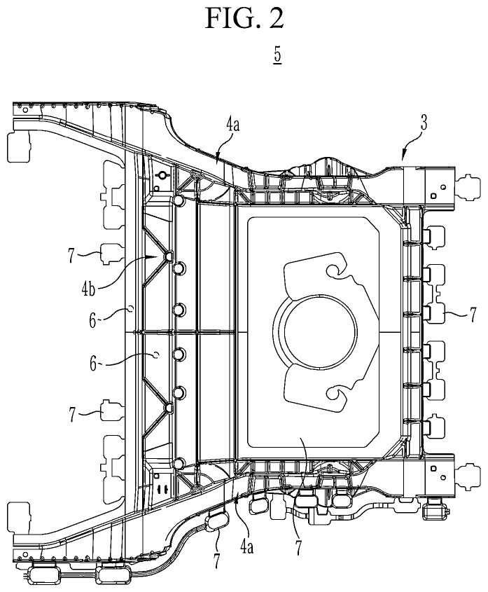

As illustrated in FIG. 2, in an embodiment, the cast product 5 includes: a side portion 4a in which the vehicle body components 3 are integrated, and a follower portion 4b. In addition, the cast product 5 includes a plurality of cast scraps 7 formed in the side portion 4a and the follower portion 4b.

In the present disclosure, reference directions for describing the following components may be set as an up and down direction and a horizontal direction according to left and right and front and rear directions.

In addition, in the present disclosure, ‘upper end portion’, ‘upper portion’, ‘upper end’ or ‘upper portion surface’ of a component refers to an end portion, a portion, an end, or a surface of a component that is located on a relatively upper side in the drawing, and ‘lower end portion’, ‘lower portion’, ‘lower end’ or ‘lower portion surface’ of a component refers to an end portion, a portion, an end, or a surface of a component that is located on a relatively lower side in the drawing.

Furthermore, in the present disclosure, an end (e.g., one end or another end, etc.) of a component refers to an end of the component in any one direction, and an end portion (e.g., one end portion or the other end portion, etc.) of a component refers to a certain part of the component including its tip.

According to an embodiment of the present disclosure, the post-processing device 100 of the cast product is configured to post-process the large cast product 5 in which the vehicle body components 3 are integrated by using simple processing equipment.

To this end, the post-processing device 100 of the cast product may include a first press mold 10 and a second press mold 50.

Here, the cast product 5 may be firstly post-processed in the first press mold 10, secondly post-processed in the second press mold 50, and manufactured as the vehicle body assembly 1.

Furthermore, the cast product 5 may be loaded into the first press mold 10 by a first robot hanger 8a. The first press mold 10 may firstly post-process the cast product 5, and the firstly post-processed cast product 5 may be loaded on the second press mold 50 by a second robot hanger 8b. In addition, the second press mold 50 may secondly post-process the cast product 5, and the secondly post-processed vehicle body assembly 1 may be loaded on an alignment unit 9 by a third robot hanger 8c.

Referring to FIGS. 1 and 2, in an embodiment of the present disclosure, the first press mold 10 trims the cast scraps 7 of the cast product 5 and processes at least one hole 6 (shown by a dashed line in FIG. 2) in the follower portion 4b of the cast product 5.

The first press mold 10 includes a first lower die 11, a first upper die 13, a trimming unit 21, and a piercing unit 31.

In an embodiment of the present disclosure, the first lower die 11 is fixed to the floor of a process workshop. The first lower die 11 includes a first lower base 15 supporting (or fixing) a lower part of the cast product 5.

In an embodiment of the present disclosure, the first upper die 13 is installed to be movable in an up and down direction in correspondence to the first lower die 11. The first upper die 13 may be reciprocated in the up and down direction by a hydraulic cylinder device known to those having ordinary skill in the art.

The first upper die 13 includes a first upper base 17 supporting (or fixing) an upper part of the cast product 5.

Referring to FIGS. 1 and 2, in an embodiment of the present disclosure, the trimming unit 21 is configured to trim the cast scraps 7 of the cast product 5.

The trimming unit 21 is installed on the first lower die 11 and the first upper die 13 of the first press mold 10.

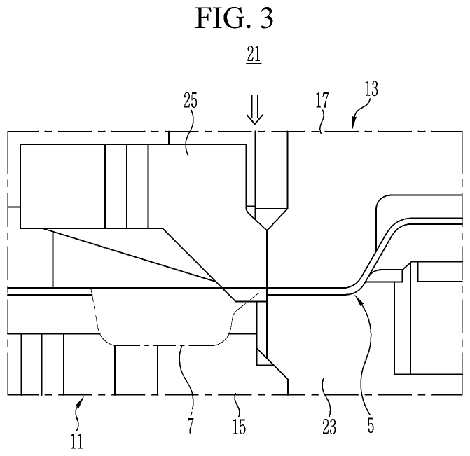

FIG. 3 is a diagram showing a trimming unit applied to the post-processing device of the cast product according to an embodiment of the present disclosure.

Referring to FIGS. 1 and 3, the trimming unit 21 according to an embodiment of the present disclosure includes a plurality of lower trimming steels 23 and a plurality of upper trimming steels 25.

The lower trimming steels 23 are configured to support a set part of the cast product 5 (i.e., a portion to which the cast scraps 7 are connected). The lower trimming steels 23 may be installed on the first lower base 15 of the first lower die 11.

Also, the upper trimming steels 25 are configured to cut the cast scraps 7 supported on the lower trimming steels 23. The upper trimming steels 25 may be installed on the first upper base 17 of the first upper die 13 at positions corresponding to the lower trimming steels 23.

Referring to FIGS. 1 and 2, in an embodiment of the present disclosure, the piercing unit 31 is configured to process at least one hole 6 in the follower portion 4b of the cast product 5.

The piercing unit 31 is installed in each of the first lower die 11 and the first upper die 13 of the first press mold 10.

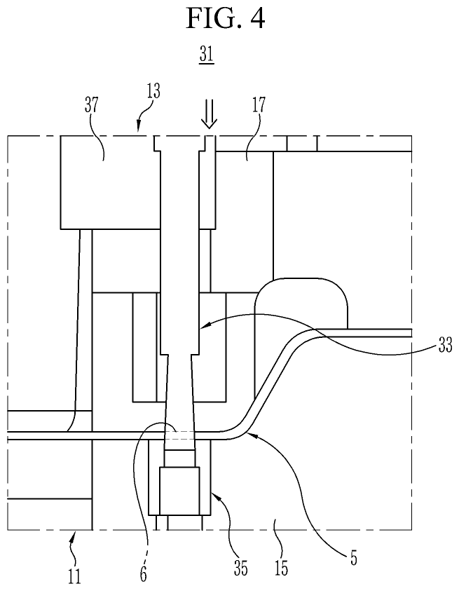

FIG. 4 is a diagram showing a piercing unit applied to the post-processing device of the cast product according to an embodiment of the present disclosure.

Referring to FIGS. 1 and 4, the piercing unit 31 according to an embodiment of the present disclosure includes a piercing tool 33 and a tool support member 35.

The piercing tool 33 may be installed on the first upper base 17 of the first upper die 13. The piercing tool 33 may pierce the cast product 5 by a pressing force of the first upper die 13 and process the at least one hole 6 (hereinafter see FIG. 2).

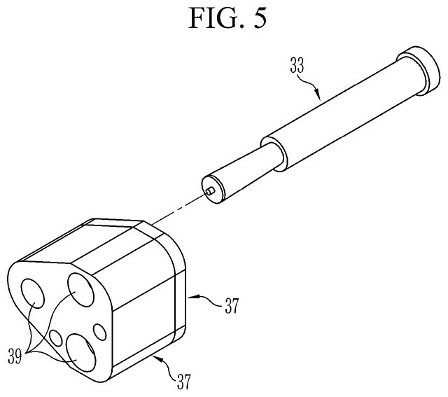

Here, the piercing tool 33 may be installed on a mounting block 37 mounted on the first upper base 17. As shown in FIG. 5, the mounting block 37 includes a plurality of mounting holes 39 formed in different sizes.

Accordingly, the piercing tool 33 may be attached to or detached from the mounting holes 39. In other words, the piercing tool 33 may be provided with different specifications corresponding to each of the mounting holes 39. Accordingly, the piercing tool 33 may pierce-process the holes 6 of various sizes in the cast product 5.

Also, the tool support member 35 is configured to support the piercing tool 33 piercing the cast product 5.

The tool support member 35 may be installed on the first lower base 15 of the first lower die 11 at a position corresponding to the piercing tool 33. For example, the tool support member 35 may be provided, for example, in a cylindrical shape with open upper and lower ends.

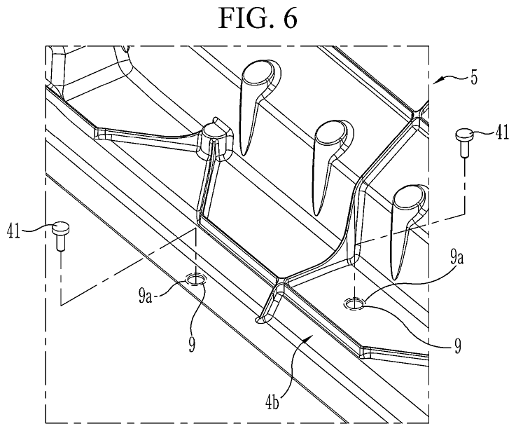

Referring to FIG. 6, hardware 41 may be fastened to the at least one hole 6 processed by the piercing unit 31. The hardware 41 may be a fastening component such as a bolt, a nut, and a clip. Hereinafter, a bolt is described as an example of the hardware 41.

Referring to FIGS. 1 and 2, in an embodiment of the present disclosure, the second press mold 50 is configured to calibrate dimensions of the vehicle body components 3 of the cast product 5, and fasten the hardware 41 (see FIG. 6) to the at least one hole 6 formed in the cast product 5.

In one embodiment, the second press mold 50 includes a second lower die 51, a second upper die 53, a dimension calibration unit 61, and a hardware fastening unit 81.

In an embodiment of the present disclosure, the second lower die 51 is fixed to the floor of a process workshop. The second lower die 51 includes a second lower base 55 supporting (or fixing) the lower part of the cast product 5 that is firstly post-processed by the first press mold 10.

In an embodiment of the present disclosure, the second upper die 53 is installed to be movable in an up and down direction in correspondence to the second lower die 51. The second upper die 53 may be reciprocated in the up and down direction by a hydraulic cylinder device.

The second upper die 53 includes a second upper base 57 supporting (or fixing) an upper part of the cast product 5 that is firstly post-processed by the first press mold 10.

Referring to FIGS. 1 and 2, in an embodiment of the present disclosure, the dimension calibration unit 61 is configured to calibrate the dimensions of the vehicle body components 3 of the cast product 5.

The dimension calibration unit 61 is installed in the second lower die 51 and the second upper die 53 of the second press mold 50.

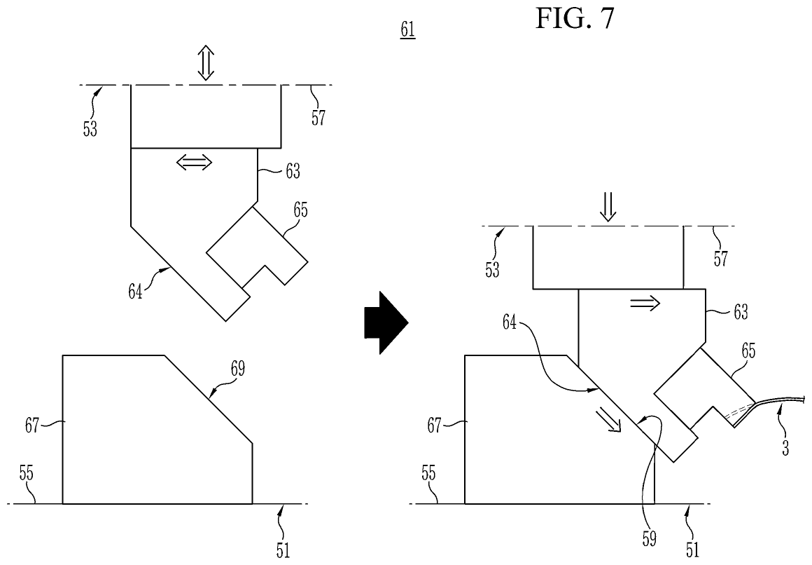

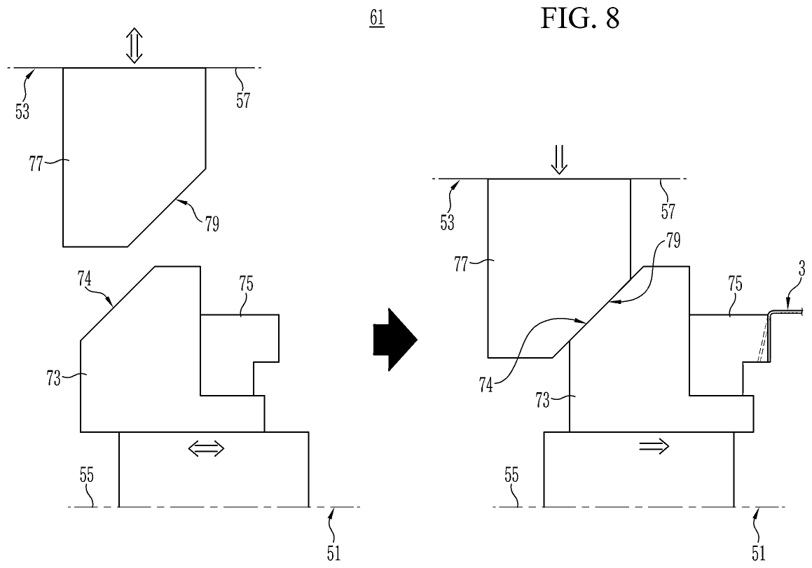

FIGS. 7 and 8 are diagrams showing a dimension calibration unit applied to the post-processing device of the cast product according to an embodiment of the present disclosure.

In an embodiment of the present disclosure, as illustrated in FIGS. 1, 7 and 8, the dimension calibration unit 61 may include a first cam slide 63, a first calibration block 65, and a first cam drive 67.

The first cam slide 63 is installed on the second upper base 57 of the second upper die 53 to be slidably movable in a horizontal direction.

The first cam slide 63 may be coupled to a rail structure (not shown) provided on the second upper base 57 to reciprocate and be slidably movable in the horizontal direction.

The first cam slide 63 includes a first cam inclined surface 64 formed in an up and down diagonal direction.

The first calibration block 65 is configured to press calibration parts of the vehicle body components 3 in the up and down diagonal direction and calibrate dimensions of the calibration parts. The first calibration block 65 is coupled to the first cam slide 63.

Also, the first cam drive 67 is configured to slidably move the first cam slide 63 in a diagonal direction.

The first cam drive 67 is fixed to the second lower base 55 of the second lower die 51.

The first cam drive 67 includes a first guide surface 69 that is in cam contact (or slip contact) with the first cam inclined surface 64 of the first cam slide 63.

Therefore, when the second upper die 53 descends, as the first cam inclined surface 64 of the first cam slide 63 is in cam contact with the first guide surface 69 of the first cam drive 67, the first cam slide 63 moves in the horizontal direction and the diagonal direction. Accordingly, the first calibration block 65 may press the calibration parts of the vehicle body components 3 in the diagonal direction by the first cam slide 63.

According to an embodiment of the present disclosure, the dimension calibration unit 61 may include a second cam slide 73, a second calibration block 75, and a second cam drive 77, as shown in FIG. 8.

The second cam slide 73 is installed on the second lower base 55 of the second lower die 51 to be slidably movable.

The second cam slide 73 may be coupled to a rail structure (not shown) provided on the second lower base 55 to reciprocate and be slidably movable in the horizontal direction.

The second cam slide 73 includes a second cam inclined surface 74 formed in the up and down diagonal direction.

The second calibration block 75 is configured to press the calibration parts of the vehicle body components 3 in the horizontal direction and calibrate the dimensions of the calibration parts. The second calibration block 75 is coupled to the second cam slide 73.

Also, the second cam drive 77 is configured to slidably move the second cam slide 73 in the horizontal direction.

The second cam drive 77 is fixed to the second upper base 57 of the second upper die 53. The second cam drive 77 includes a second guide surface 79 that is in cam contact (or slip contact) with the second cam inclined surface 74 of the second cam slide 73.

Therefore, when the second upper die 53 descends, as the second guide surface 79 of the second cam drive 77 is in cam contact with the second cam inclined surface 74 of the second cam slide 73, the second cam slide 73 moves in the horizontal direction. Accordingly, the second calibration block 75 may press the calibration parts of the vehicle body components 3 in the horizontal direction by the second cam slide 73.

Referring to FIGS. 1 and 6, in an embodiment of the present disclosure, the hardware fastening unit 81 is configured to fasten the hardware 41 to the at least one hole 6 formed in the cast product 5.

The hardware fastening unit 81 is installed on the second lower die 51 and the second upper die 53 of the second press mold 50.

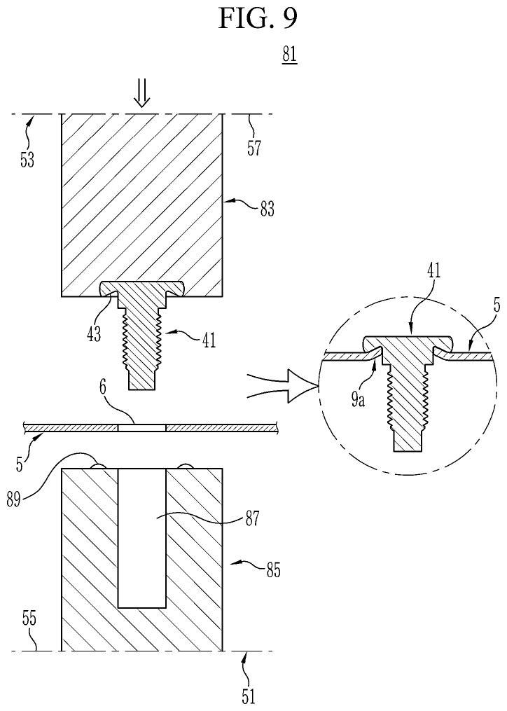

FIG. 9 is a diagram showing a hardware fastening unit applied to the post-processing device of the cast product according to an embodiment of the present disclosure.

Referring to FIGS. 1 and 9, the hardware fastening unit 81 according to an embodiment of the present disclosure includes a hardware punch unit 83 and an anvil unit 85.

The hardware punch unit 83 is installed on the second upper base 57 of the second upper die 53 to be movable in an up and down direction.

The hardware punch unit 83 is configured to punch the separately supplied hardware 41 into the at least one hole 6 of the cast product 5 by hydraulic or pneumatic pressure.

Also, the anvil unit 85 is configured to support a hole processing unit 9a (see FIG. 6) of the cast product 5, plastically deform the hole processing unit 9a of the cast product 5 by a punch pressure of the hardware punch unit 83, and fasten the hardware 41 to the hole processing unit 9a. Here, the hole processing unit 9a may be defined as an edge portion of the at least one hole 6 formed in the cast product 5.

The anvil unit 85 is fixed to the second lower base 55 of the second lower die 51. In an example, the anvil unit 85 includes an accommodation groove 87 that accommodates the hardware 41.

Furthermore, the anvil unit 85 includes an anvil protrusion 89 formed on an upper end thereof to plastically deform the hole processing unit 9a.

Here, the hole processing unit 9a may be plastically deformed by the anvil protrusion 89 and fastened to a fastening groove 43 formed in a head portion of the hardware 41.

Hereinafter, the operation of the post-processing device 100 of the cast product according to an embodiment of the present disclosure is described in detail with reference to FIGS. 1 to 9.

In an embodiment of the present disclosure, the large cast product 5 in which the vehicle body components 3 are integrated is molded by using a hyper casting method in a vehicle body casting process.

The cast product 5 is transferred through a post-processing process, and is loaded on the first lower die 11 of the first press mold 10 by the first robot hanger 8a in the post-processing process. At this time, the first upper die 13 is moved in an upper direction.

In this state, when the first upper die 13 is moved in a lower direction, the cast product 5 is fixed by the first lower base 15 of the first lower die 11 and the first upper base 17 of the first upper die 13.

At the same time, while the lower trimming steels 23 of the first lower die 11 support the cast scraps 7, the upper trimming steels 25 of the first upper die 13 trim the cast scraps 7.

In addition, the piercing tool 33 pierces the cast product 5 by a pressing force of the first upper die 13, and processes the at least one hole 6 in a set part of the cast product 5. At this time, the tool support member 35 may discharge a processing chip while supporting the piercing tool 33.

Accordingly, the cast product 5 is firstly trimmed and hole processed by the trimming unit 21 and the piercing unit 31 in the first press mold 10.

Next, when the first upper die 13 is moved in the upper direction, the firstly post-processed cast product 5 is loaded on the second lower die 51 of the second press mold 50 by the second robot hanger 8b. At this time, the second upper die 53 is moved in the upper direction.

In this state, when the second upper die 53 is moved in the lower direction, the firstly post-processed cast product 5 is fixed by the second lower base 55 of the second lower die 51 and the second upper base 57 of the second upper die 53.

At the same time, the first cam inclined surface 64 of the first cam slide 63 installed on the second upper die 53 is in cam contact with the first guide surface 69 of the first cam drive 67 installed on the second lower die 51, and the first cam slide 63 is moved in the horizontal direction and the diagonal direction.

Accordingly, the first calibration block 65 presses the calibration parts of the vehicle body components 3 in the diagonal direction by the first cam slide 63 and calibrates dimensions of the calibration parts.

During this process, the second guide surface 79 of the second cam drive 77 installed on the second upper die 53 is in cam contact with the second cam inclined surface 74 of the second cam slide 73 installed on the second lower die 51, and the second cam slide 73 is moved in the horizontal direction.

Accordingly, the second calibration block 75 presses the calibration parts of the vehicle body components 3 in the horizontal direction by the second cam slide 73 and calibrates the dimensions of the calibration parts.

In addition, while the anvil unit 85 installed in the second lower die 51 supports the hole processing unit 9a of the cast product 5, the hardware punch unit 83 installed in the second upper die 53 punches the hardware 41 into the at least one hole 6. Here, the hardware punch unit 83 may punch the hardware 41 into the at least one hole 6 by hydraulic or pneumatic pressure.

Then, the hole processing unit 9a is plastically deformed by the anvil unit 85 and is fastened to the hardware 41. Accordingly, the hardware 41 may be fastened to the hole processing unit 9a of the cast product 5.

Accordingly, the cast product 5 is secondly post-processed by the dimension calibration unit 61 and the hardware fastening unit 81 in the first press mold 10, and is manufactured as the standardized vehicle body assembly 1.

Next, when the second upper die 53 is moved in the upper direction, the vehicle body assembly 1 is loaded on the alignment unit 9 by the third robot hanger 8c.

As described above, the post-processing device 100 of the cast product according to the embodiment of the present disclosure may firstly post-process the large cast product 5 by the trimming unit 21 and the piercing unit 31 of the first press mold 10.

In addition, the post-processing device 100 of the cast product according to an embodiment of the present disclosure may secondly post-process the cast product 5 that is firstly post-processed by the first press mold 10 by the dimension calibration unit 61 and hardware fastening unit 81 of the second press mold 50.

Meanwhile, in the related art, a standardized vehicle body assembly is manufactured by individually post-processing and assembling vehicle body components molded by using a casting method.

However, the post-processing device 100 of the cast product according to an embodiment of the present disclosure post-processes the large cast product 5 in which the vehicle body components 3 are integrated by using a hyper casting method, by using the first press mold 10 and the second press mold 50, thereby manufacturing the standardized vehicle body assembly 1.

As a result, the post-processing device 100 of the cast product according to an embodiment of the present disclosure may actively respond to recent casting molding technology that enlarges and integrates the cast product by using the hyper casting method.

In addition, according to the post-processing device 100 of the cast product according to an embodiment of the present disclosure, the large cast product 5 is post-processed in a simple process using press mold technology, and thus, cycle time may be shortened, and investment cost and installation space of post-processing equipment may be reduced.

Although some embodiments of the present disclosure have been described above, the present disclosure is not limited thereto, and various modifications and implementations are possible within the scope of the claims and the description and the accompanying drawings, and it is natural that this also falls within the scope of the present disclosure.

### DESCRIPTION OF SYMBOLS

1: vehicle body assembly
3: vehicle body component
4a: side portion
4b: follower portion
5; cast product
6: hole
9a: hole processing unit
7: cast scrap
8a: first robot hanger
8b: second robot hanger
8c: third robot hanger
9: alignment unit
10: first press mold
11: first lower die
13: first upper die
15: first lower base
17: first upper base
21: trimming unit
23: lower trimming steel
25: upper trimming steel
31: piercing unit
33: piercing tool
35: tool support member
37: mounting block
39: mounting hole
41: hardware
43: fastening groove
50: second press mold
51: second lower die
53: second upper die
55: second lower base
57: second upper base
61: dimension calibration unit
63: first cam slide
64: first cam inclined surface
65: first calibration block
67: first cam drive
69: first guide surface
73: second cam slide
74: second cam inclined surface
75: second calibration block
77: second cam drive
79: second guide surface
81: hardware fastening unit
83: hardware punch unit
85: anvil unit
87: accommodation groove
89: anvil protrusion
100: post-processing device of cast product

What is claimed is:

1. A post-processing device of a cast product, which is configured to post-process the cast product in which a plurality of components is integrated, the post-processing device of the cast product comprising:
a first press mold configured to trim cast scraps of the cast product and process at least one hole into the cast product; and
a second press mold configured to calibrate dimensions of the plurality of components and fasten hardware to the at least one hole.

2. The post-processing device of claim 1, wherein:
the cast product is loaded on the first press mold by a first robot hanger, and
the cast product post-processed in the first press mold is loaded on the second press mold by a second robot hanger.

3. A post-processing device of a cast product, which is configured to post-process the cast product in which a plurality of components are integrated, the post-processing device of the cast product comprising:
a first press mold including a trimming unit installed on a first lower die and a first upper die to trim cast scraps of the cast product; and
a second press mold including a dimension calibration unit installed in a second lower die and a second upper die to calibrate dimensions of the plurality of components.

4. The post-processing device of claim 3, wherein
the first press mold further includes a piercing unit installed in the first lower die and the first upper die to process at least one hole into the cast product.

5. The post-processing device of claim 4, wherein
the second press mold further includes a hardware fastening unit installed in the second lower die and the second upper die to fasten hardware to the at least one hole.

6. The post-processing device of claim 3, wherein the trimming unit includes:
a plurality of lower trimming steels installed in the first lower die; and
a plurality of upper trimming steels installed in the first upper die in correspondence to the plurality of lower trimming steels.

7. The post-processing device of claim 4, wherein the piercing unit includes:
a piercing tool installed in the first upper die; and
a tool support member installed in the first lower die in correspondence to the piercing tool.

8. The post-processing device of claim 7, wherein the piercing tool is installed on a mounting block mounted on the first upper die and provided in the mounting block to be detachable from a plurality of mounting holes formed in different sizes.

9. The post-processing device of claim 3, wherein the dimension calibration unit includes:
a first cam slide installed on the second upper die and configured to be slidably movable in a horizontal direction and having a first cam inclined surface formed thereon;
a first calibration block coupled to the first cam slide and configured to press calibration parts of the plurality of components; and
a first cam drive installed on the second lower die and configured to slidably move the first cam slide in a diagonal direction, and having a first guide surface in cam contact with the first cam inclined surface.

10. The post-processing device of claim 9, wherein the dimension calibration unit includes:
a second cam slide installed on the second lower die and configured to be slidably movable in the horizontal direction and having a second cam inclined surface formed thereon;
a second calibration block coupled to the second cam slide and configured to press the calibration parts of the plurality of components; and
a second cam drive installed on the second upper die and configured to slidably move the second cam slide in the horizontal direction, and having a second guide surface in cam contact with the second cam inclined surface.

11. The post-processing device of claim 5, wherein the hardware fastening unit includes:
a hardware punch unit installed in the second upper die and configured to be movable in an up and down direction; and
an anvil unit configured to plastically deform a hole processing unit of the cast product by a punch pressure of the hardware punch unit, and installed on the second lower die to fasten the hardware to the hole processing unit.

12. A post-processing device for a cast product, comprising:
a first press mold including:
a trimming unit installed on a first lower die and a first upper die and configured to trim cast scraps of the cast product, and
a piercing unit installed in the first lower die and the first upper die and configured to process at least one hole into the cast product; and
a second press mold including:
a dimension calibration unit installed in a second lower die and a second upper die and configured to calibrate dimensions of a plurality of components of the cast product; and
a hardware fastening unit installed in the second lower die and the second upper die to fasten hardware to the at least one hole.

13. The post-processing device of claim 12, wherein the dimension calibration unit includes:
a first cam slide installed on the second upper die and configured to be slidably movable in a horizontal direction and having a first cam inclined surface formed thereon;
a first calibration block coupled to the first cam slide and configured to press calibration parts of the plurality of components; and
a first cam drive installed on the second lower die and configured to slidably move the first cam slide in a diagonal direction, and having a first guide surface in cam contact with the first cam inclined surface.

14. The post-processing device of claim 13, the dimension calibration unit includes:
a second cam slide installed on the second lower die and configured to be slidably movable in the horizontal direction and having a second cam inclined surface formed thereon;
a second calibration block coupled to the second cam slide and configured to press the calibration parts of the plurality of components; and
a second cam drive installed on the second upper die and configured to slidably move the second cam slide in the horizontal direction, and having a second guide surface in cam contact with the second cam inclined surface.
